(19) United States
(12) Patent Application Publication
(10) Pub. No.: US 2021/0059139 A1
(43) Pub. Date: Mar. 4, 2021

(54) WALL LANDSCAPING SYSTEM FOR EASY GROWTH MANAGEMENT WITH AUTOMATIC WATERING AND PLANT GROWTH ANALYSIS

(71) Applicant: JANG AUTOMATION CO., LTD., Cheongju-si (KR)

(72) Inventor: Jae Su Jang, Cheongju-si (KR)

(73) Assignee: JANG AUTOMATION CO., LTD., Cheongju-si (KR)

(21) Appl. No.: 16/578,948

(22) Filed: Sep. 23, 2019

(30) Foreign Application Priority Data
Aug. 30, 2019 (KR) 10-2019-0107376

(51) Int. Cl. A01G 31/02; A01G 27/00; G01N 21/84; G06T 7/12; G06T 7/11; G06T 7/00

(52) U.S. Cl. CPC A01G 31/02; A01G 27/001; A01G 27/003; G01N 21/84; G06T 7/12; G06T 2207/10048; G06T 7/0004; G01N 2021/8466; G06T 2207/10028; G06T 2207/30188; G06T 7/11

(57) ABSTRACT

Disclosed is a wall landscaping system for easy growth management with automatic watering and plant growth analysis, which creates a vertical garden on an interior or exterior wall of a structure, the system including: a main body (10) installed to cover the wall (W) to have a plant grown thereon; a watering part (20) disposed at an upper end of the main body (10) to supply water to the plant; a detector (30) disposed around the main body (10) to photograph the plant; and a controller (40) automatically checking and recording a growth state of the plant by analyzing an image photographed by the detector (30), and remotely notifying a manager according to the growth state of the plant, whereby it is possible to automatically supply water at a predetermined interval for each plant, and analyze the growth state of the plant and notify the same.

### CROSS REFERENCE TO RELATED APPLICATION

The present application claims priority to Korean Patent Application No. 10-2019-0107376, filed Aug. 30, 2019, the entire contents of which is incorporated herein for all purposes by this reference.

### BACKGROUND OF THE INVENTION

### Field of the Invention

The present invention relates to a wall landscaping system creating a vertical garden on interior and exterior walls of a structure to improve global warming measures and perform fine dust purification, as well as reduce cooling and heating energy using a wall greening technology of carbonized cork which is a material for internal and external combustion, soundproofing, and insulation. More particularly, the present invention relates to a wall landscaping system that facilitates the growth management of plants and has an intelligent air cleaning function creating an optimal environment according to the surrounding environment and an advertisement function implementing letters or pictures with plants created on the wall, by applying a watering system that automatically supplies water at a predetermined interval for each plant and a monitoring system that automatically analyzes and announces the growth status of the plant.

### Description of the Related Art

Wall landscaping refers to a method of covering artificially constructed structures, such as walls, fences, soundproof walls, concrete retaining walls, and piers, with plants and is used to build indoor and outdoor nature-friendly structures such as public institutions, companies, and schools.

In other words, the wall landscaping is a nature-friendly interior design that combines the art of painting and sculpture, the natural elements that make use of the charm of leaves and flowers, the artificial element of a horticultural environment, and the resulting aesthetic and landscape element. Such wall landscaping has other effects such as air purification and noise reduction.

According to the Korean Ministry of Land, Transport, and Maritime Affairs (2009-905), it says that “wall greening is defined as planting or covering all or a part of a wall of a building or structure with plants”, and green walls, plant walls, eco-walls, vertical greening, and vertical gardens are used in the same sense as wall greening.

Wall greening refers to covering the walls of buildings, walls of structures such as fences surrounding buildings, retaining walls of roads, walls of civil structures such as banks of banks and embankments, and the facades of fairs, exhibitions, and venues, with plants.

In addition to rooftop greening, wall greening allows three-dimensional greening of buildings and structures that are artificially constructed in cities with insufficient green spaces, thereby enabling formation of urban ecosystems and creation of a pleasant environment. It is possible to make people feel comfort and abundance in the city by expanding the space where creatures can live in the inorganic urban space and increasing the greening that enables people to come into contact with nature.

In addition, there are advantages that a heat island phenomenon of the city is reduced, energy is reduced by the thermal insulation performance of a building, and the wall is protected by preventing cracking thereof. In addition, it is possible to increase the greening ratio since wall greening is artificial ground landscaping.

In addition, wall greening indoor literally means creating green space on the vertical surface of the building's interior space. In general, wall greening is greening on the outer wall of a structure or building that is installed outdoors, and indoor wall greening is a method of landscaping the indoor space using walls or pillars of the indoor space.

As examples of such wall landscape are disclosed in Korean Patent No. 10-1414933 (titled “Indoor and Outdoor Landscape Decoration”) and Korean Patent No. 10-1485824 (titled “Vertical Garden”)

According to the disclosed publications, the structures thereof are slightly different from each other, but a watering system automatically supplying water to plants according to a prescribed interval is provided, together with a cork board where plants are grown on the interior and exterior walls, thereby improving convenience of plant growth management.

Here, the maintenance of wall landscaping is most important. However, there is a problem that maintenance is often difficult in terms of manpower and cost. In other words, the proper supply of moisture is required to be supplied to the plants, as well as the plants has to be inevitably replaced when the plants are planted in a fresh state and then the plants wither or deteriorate during growth.

Therefore, when such problems occur, it is necessary to introduce a system that accurately measures and automatically determinate the growth state of the plants in order to solve the problems.

### DOCUMENTS OF RELATED ART

(Patent Document 0001) Korean Patent NO. 10-1414933 (titled “Indoor and Outdoor Landscape Decoration”); and

(Patent Document 0002) Korean Patent NO. 10-1485824 (titled “Vertical Garden”

### SUMMARY OF THE INVENTION

The present invention has been made keeping in mind the above problems occurring in the related art, and an object of the present invention is to provide a wall landscaping system that enables rapid actions and allows anyone to quickly and easily manage plants, regardless of skill or experience, by applying a watering system that automatically supplies water at a predetermined interval for each plant and a monitoring system that automatically analyzes and announces the growth status of the plants.

In order to achieve the object, the present invention relates to a wall landscaping system for easy growth management with automatic watering and plant growth analysis, which creates a vertical garden on an interior or exterior wall of a structure, the system including a main body installed to cover the wall to have a plant grown thereon; a watering part disposed at an upper end of the main body to supply water to the plant; a detector disposed around the main body to photograph the plant; and a controller automatically checking and recording a growth state of the plant by analyzing an image photographed by the detector, and remotely notifying a manager according to the growth state of the plant.

Herein, the main body may include multiple skeletal pipes attached to the wall in a form of a grid; a support plate attached to outer surfaces of the skeletal pipes and finished in a plane; a waterproof cloth attached to an outer surface of the support plate to block moisture; a root-resistant film attached to an outer surface of the waterproof cloth to block penetration of plant roots; and one or more plantation boards attached to an outer surface of the root-resistant film to have the plant grown thereon.

Further, the plantation board may be formed of raw cork or carbonized cork or a mixture thereof, and the plantation board has multiple planting holes formed on one surface thereof, the planting holes being perforated in a predetermined size and direction and having the plant grown therein, and is integrally formed with a flame-resistant layer that blocks deformation and combustion by heat on an outer surface thereof.

Further, the flame-resistant layer may be composed of 5.0 to 10% by weight of boron, 0.5 to 1.0% by weight of boric acid, 0.5 to 1.5% by weight of phosphoric acid, 10 to 20% by weight of phosphate ester, 1.0 to 2.0% by weight of ethyl phosphoric acid, 0.1 to 1.0 by weight of ammonia, 1.0 to 5.5% by weight of ethanol amine, remaining balance of unavoidable impurities, and water as a solvent.

In addition, the main body may further include a reinforcing pipe attached between the waterproof cloth and the root-resistant film to increase durability.

In addition, the watering part may include a watering pipe disposed across the upper end of the main body, a watering nozzle continuously arranged at a lower end of the watering pipe to discharge water downward in a drop manner, and a watering machine connected to the watering pipe and supplying water at a prescribed interval.

In addition, the watering machine may include an on-off valve supplying water from the outside in accordance with a signal; a water tank storing the supplied water at a predetermined capacity; a pump pumping the stored water into the watering pipe; a filter for filtering the pumped water; a pressure reducing valve controlling a flow rate of the pumped water; and a timer operating the pump at a predetermined interval.

In addition, the detection unit may include a color camera photographing color of the plant that is disposed to be grown toward the front of the main body and a depth camera disposed on the same line as the color camera to photograph a size of the plant to a depth by an infrared light reflected from the main body.

In addition, the controller may include a load module making a request for a color image and a depth image to be received; an adjustment module setting a range of the main body as an analysis area in the color image and the depth image; an arrangement module partitioning a boundary zone for each planting area by extracting only the set analysis area; a capture module extracting and recording an image as a picture at a predetermined interval; an analysis module determining a growth state of the plant by average color and depth of the plant for each zone in the recorded picture; an output module displaying the growth state of each boundary zone in the analyzed picture by colors capable of being distinguished by a naked eye; and a notification module notifying the manager of the growth status of the plant of each boundary zone with visual and audible information.

In addition, the wall landscaping system may further include a auxiliary unit having any one of an artificial air purifier disposed at an upper end of the main body and blowing filtered air toward the plant to double self-cleaning and transpiration of the plant and a billboard having a mulching material to which different seeds are embedded in forms of letters, patterns, and pictures to the main body to guide information identified by colors of the grown plants, or a combination thereof.

A method of embedding a seed in the mulching material according to the present invention, which provides easy growth management with automatic watering and plant growth analysis, includes: preparing different kinds of seeds to be embedded in the mulching material; setting areas to which the different kind of seeds are embedded in the mulching material;

specifying seeds to be embedded according to the areas set in the mulching material; inputting a file created by specifying the seeds to be embedded according to the areas set in the mulching material to a control unit that controls an on-off valve operation of a seed embedment device composed of multiple hoppers each having an on-off valve and the control unit and a position movement of the hopper; introducing the seeds to be embedded to the set areas into a seed storage hopper; and embedding the different seeds stored in the hopper to each area.

As described in the above configuration and operation, the present invention provides the following effects.

First, rapid actions are enabled and anyone can quickly and easily manage the plants, regardless of skill or experience, by applying a watering system that automatically supplies water at a predetermined interval for each plant and a monitoring system that automatically analyzes and announces the growth status of the plants.

Second, as a flame-resistant layer is coated on the plantation board, it is possible to expect long life with excellent antiseptic and insect repellent characteristics, while preventing deformation and combustion by heat.

Third, an air purifier equipped with artificial intelligence blows the filtered air toward the plants according to the surrounding environment to double the self-cleaning and transpiration of the plants, thereby creating a more comfortable environment.

Fourth, mulching materials in which different seeds are embedded in the form of letters, patterns, and pictures is installed in the billboard are installed to guide the information that can be identified by the color of the growing plants, thereby stimulating interest and generating additional profits through promotional functions.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above and other objects, features and other advantages of the present invention will be more clearly understood from the following detailed description when taken in conjunction with the accompanying drawings, in which:

FIG. 1 is a perspective view showing a wall landscaping system as a whole;

FIG. 2 is an exploded view showing a main body of a wall landscaping system according to the present invention;

FIG. 3 is a partial cross-sectional view showing the main body of the wall landscaping system according to the present invention;

FIG. 4 is a system diagram showing a watering part of the wall landscaping system according to the present invention;

FIG. 5 is a block diagram showing a controller of the wall landscaping system according to the present invention;

FIGS. 6A to 10 are reference pictures showing a process of analyzing a plant growth state by the controller of the wall landscaping system according to the present invention;

FIG. 11 is a graph showing an experiment result of the wall landscaping system according to the present invention;

FIG. 12 is a perspective view showing a modification of the wall landscaping system according to the present invention;

FIG. 13 is a reference picture showing a modification of the wall landscaping system according to the present invention;

FIG. 14 is a block diagram showing a process of embedding seeds in a mulching material according to the present invention;

FIG. 15 is a perspective view showing an apparatus for embedding seeds in a mulching material according to the present invention; and

FIG. 16 is a block diagram showing a concept of embedding seeds in a mulching material according to the present invention.

### DETAILED DESCRIPTION OF THE INVENTION

Hereinafter, with reference to the accompanying drawings, the configuration of the present invention and its effects will be described.

The terms or words used in this specification and claims are not to be construed as limiting in their usual or dictionary meanings, and should be interpreted as having a meaning and concept corresponding to the technical idea of the present invention, under a principle that the inventors may appropriately define the concepts of terms in order to best describe their invention. Therefore, since the embodiments described in the present specification and the configuration shown in the drawings are only the most preferred embodiments of the present invention, and do not represent all of the technical ideas of the present invention, it should be understood that there may be various equivalents and modifications that may substitute the technical idea at the time of the present application.

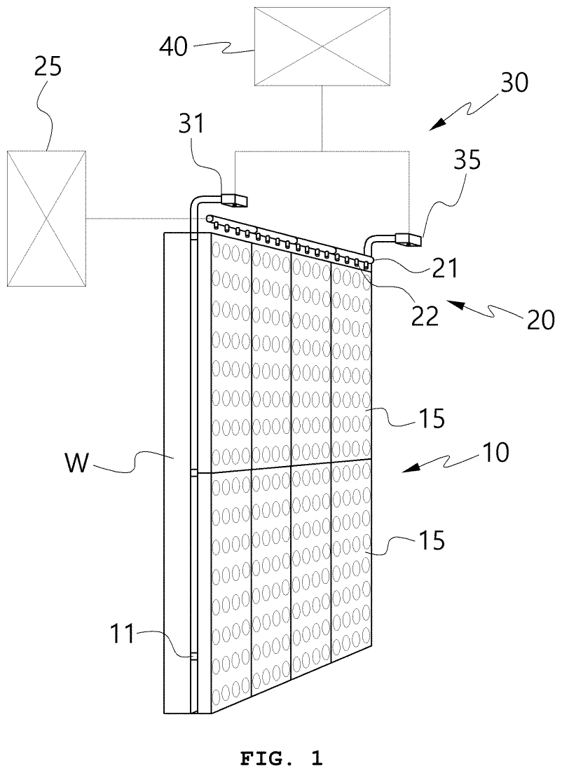

The present invention relates to a wall landscaping system creating a vertical garden on an interior or exterior wall W of the structure, the wall landscaping system including a main body 10, a watering part 20, a detector 30, and a controller 40 as main configurations as shown in FIG. 1, and making growth management easy with automatic watering and plant growth analysis.

The wall landscaping system according to the present invention enables automatically supplying water at a predetermined interval for each plant and automatically analyzing and notifying the growth states of the plants, whereby rapid actions are enabled and anyone can quickly and easily manage the plants, regardless of skill or experience

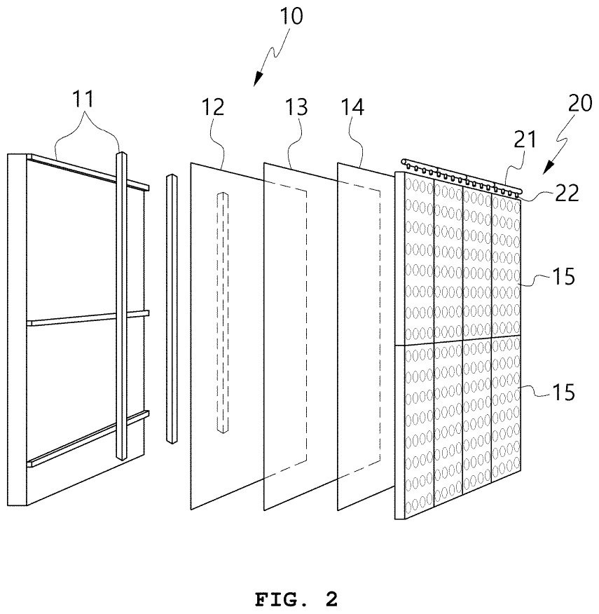

The main body 10 is installed to cover the set wall W provided in the interior and exterior of the structure as shown in FIG. 1 to create the corresponding greening wall W. The main body 10 includes a skeletal pipe 11, a support plate 12, a waterproof cloth 13, a root-resistant film 14, and a plantation board 15 as shown in FIG. 2.

The skeletal pipe 11 is a steel pipe having a size of 40 mm×40 mm, and multiple skeletal pipes 11 are attached to the wall surface W to form a grid shape in horizontal and vertical directions. The skeletal pipes 11 serve as bones that allow the support plate 12 to the plantation board 15 to be installed on the wall W.

The support plate 12 is an iron plate with a thickness of 1.2 mm or more, and is attached to the outer surfaces of the skeletal pipes 11 and then finished flat. The support plate 12 is preferably plated with zinc by performing electric or melt treatment to the outside to prevent corrosion.

The waterproof cloth 13 is a coating having a thickness of 1.5 mm or more coated with a waterproofing agent to prevent water from penetrating, and integrally attached to the outer surface of the support plate 12. The waterproof cloth 13 preferably has a coal tar adhered thereto, the coal tar having a relatively low price and excellent waterproofness.

The root-resistant film 14 is a resin film having a thickness of 2.0 mm or more so as not to allow the plant root to penetrate therethrough, and is integrally attached to the rear surface of the plantation board 15. The root-resistant film 14 is formed of a resin material of any one of polyethylene, polypropylene, polyester, polyvinyl chloride, and urethane, and is preferably coated with an adhesive for adhesion on one surface thereof.

The plantation board 15 is a compressed plate with a waterproof, soundproofing, and insulating function and a thickness of 75 mm or more, to create a soil-like environment in which plants may grow, and one or more plantation boards 15 are attached to an outer surface of the root-resistant film 14. The plantation board 15 is formed of raw cork or carbonized cork or a mixture thereof, and is provided on one surface thereof with multiple planting holes 15a perforated with a diameter of 72 mm or more at intervals of 125 mm.

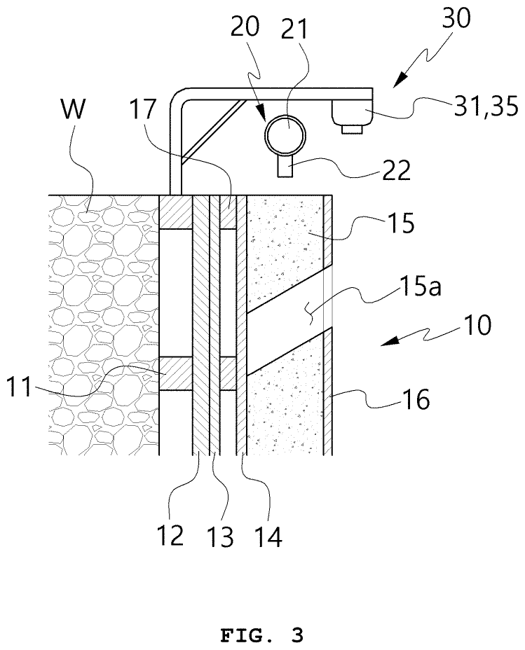

Here, the planting holes 15a may be formed to be inclined at 15°, toward the rear side, that is, downward as shown in FIG. 3. That is, the carbonized cork has a property of not absorbing water, thereby preventing the plant root from rotting through automatic drainage by the inclined planting holes 15a. In addition, the planting holes 15a, in which plants are planted, are preferably filled with natural mosses to help the plant roots stick.

Although not shown in the drawing, watering holes are formed perpendicularly to the planting holes 15a, and the watering holes are filled with the good absorbent cotton fabric, thereby allowing water to be supplied to the root of the plant in a drop manner. The plantation board 15 may be equipped with a sensor that may measure the temperature and humidity and nutrients, and may be implemented so that a self-checking function is performed with information measured by the sensor.

Herein, it is preferable that the plantation board 15 is coated on the outer surface thereof with a flame-resistant layer 16 which blocks deformation or combustion due to heat as shown in FIG. 3. The flame-resistant layer 16 is composed of 5.0-10% by weight of borax (Na₂B₄O₇.10H₂O), 0.5-1.0% by weight of boric acid (H₃BO₃), 0.5-1.5% by weight of phosphoric acid (H₃PO₄), 10-20% by weight of phosphate ester, 1.0 to 2.0% by weight of ethyl phosphoric acid, 0.1 to 1.0% by weight of ammonia, 1.0 to 5.5% by weight of ethanol amine, the remaining balance of unavoidable impurities, and water as a solvent.

The phosphate ester is triaryl phosphate; ethyl phosphate is monoethyl phosphate; ethanol amine is triethanolamine (TEA); and ammonia is used at concentration of 60%.

Preferably, the flame-resistant layer 16 is composed of 7.2% by weight of borax, 0.8% by weight of boric acid, 1.0% by weight of phosphoric acid, 16% by weight of phosphate ester, 1.5% by weight of ethyl phosphate, 0.5% by weight of ammonia, and 5.0% by weight of ethanol amine.

The plantation board 15 coated with the flame-resistant layer 16 has an excellent fire resistance performance in which even when a flame is applied for 3 seconds with a torch spaced 10 cm from one surface, the flame disappears with the removal of the torch, thereby having fire resistance that satisfies both fire safety laws and the building laws.

In addition, the main body 10 may further comprise a reinforcing pipe 17 attached between the waterproof cloth 13 and the root-resistant film 14 to increase durability as shown in FIG. 3. The reinforcing pipe 17 is an aluminum pipe having a size of 40 mm×20 mm, and is selectively attached according to the indoor and outdoor environments or the state of the wall surface W to improve the overall construction completeness.

The watering part 20 is a water supply facility that is disposed on an upper end of the main body 10 to automatically supply water to the plant, as shown in FIGS. 1 and 3. The watering part 20 is configured with a watering pipe 21, a watering nozzle 22, and a watering machine 25.

The watering pipe 21 is a pipe having a diameter of 10 mm or more and is disposed above the top of the main body 10 in a traverse direction. The watering nozzle 22 is disposed downward toward the plantation board 15 below the watering pipe 21 and supply the water supplied to the watering pipe 21 in a drop manner. Here, the watering nozzle 22 may be arranged to match the longitudinal direction of the planting holes 15a arranged on the vegetation board 15.

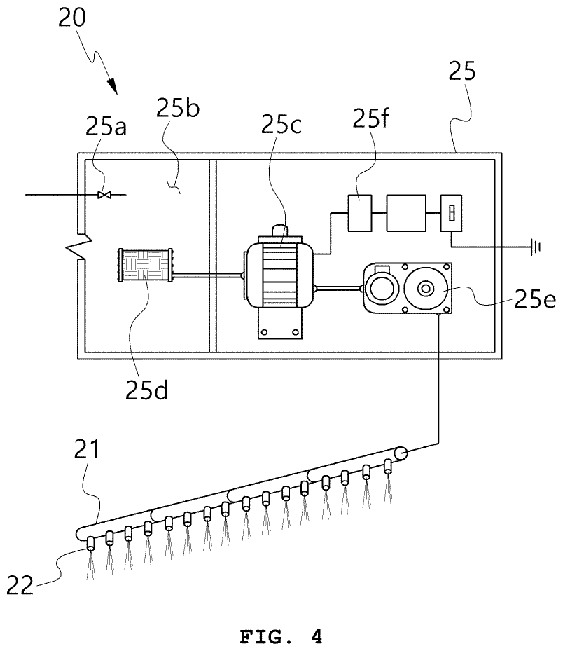

The watering machine 25 is connected to the watering pipe 21 in communication therewith to automatically supply water at every predetermined interval of time. This watering machine 25 is configured with an on-off valve 25a, a water tank 25b, a pump 25c, a filter 25d, a pressure reducing valve 25e, and a timer 25f disposed in the enclosure as shown in FIG. 4.

The on-off valve 25a is disposed in a water flow passage connecting the external water supply to the water tank 25b and opens/closes the flow path according to a signal so as to supply the water to the water tank 25b.

The water tank 25b is connected to a water flow passage to store a predetermined amount of water all the time. The water tank 25b has a detector built therein to measure the water level, thereby outputting the supply signal to the on-off valve 25a.

The pump 25c is disposed between a suction flow passage connected to the water tank 25b and a supply flow passage connected to the watering pipe 21 and is selectively operated according to a signal. That is, the pump 25c is driven in response to the signal of the timer 25f to pump the water stored in the water tank 25b into the watering pipe 21.

The filter 25d is attached to the suction flow path in a replaceable manner to filter water sucked by the pump 25c. It is preferable to use the filter 25d that has a combination of activated carbon and zeolite grains.

The pressure reducing valve 25e is disposed in the supply flow path that is between the pump 25c and the watering pipe 21 to adjust a flow rate of water being pumped. That is, the pressure reducing valve 25e adjusts the flow rate of water supplied to the watering pipe 21 to discharge the water of the watering nozzle 22 in a drop state.

The timer 25f interrupts the power supplied from the outside, and drives the pump 25c at a predetermined interval. The timer 25f is configured with a mechanical relay or an electronic relay, and it is preferable to configure a circuit breaker and a fuse together in order to prevent an electrical safety accident.

Herein, the watering machine 25 may include a cleaning module for automatically cleaning the filter 25d for filtering the water in the water tank 25b, in a periodical manner or according to contaminated state. Such a cleaning module may perform cleaning with high pressure water that is pumped in the opposite direction to the filtration, or cleaning via ionic activity caused by ultrasonic vibration or strong static electricity.

A detection unit 30 is disposed around the main body 10 as shown in FIG. 1 to photograph the plants, thereby generating an image on the growth state of the plants as analysis information. The detection unit 30 includes at least a color camera 31 and a depth camera 35 that is disposed toward the front of the main body 10 to comprehensively photograph the growing plants.

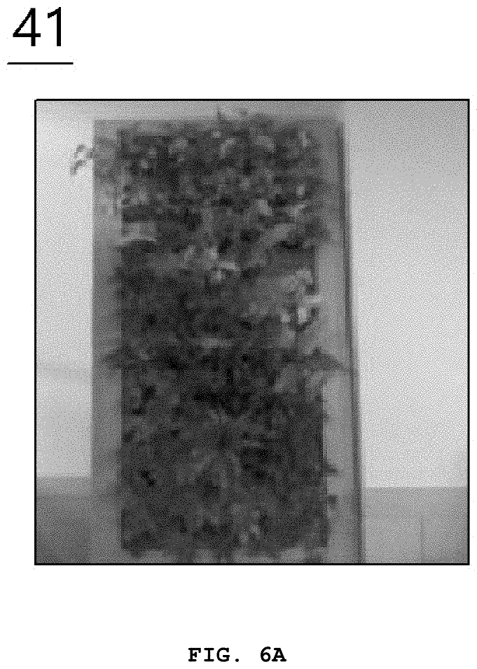

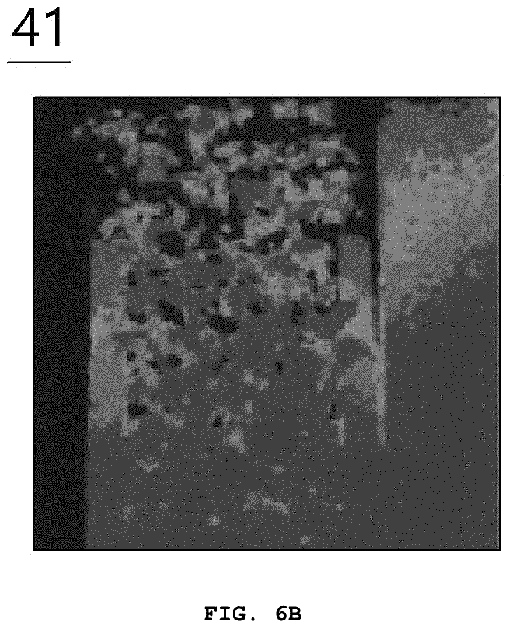

The color camera 31 is a general camera having RGB color, and preferably has a specification in which a high-definition image of HD level or higher is photographed as shown in FIG. 6A. Here, the color camera 31 may preferably have an LED light for selectively radiating light toward the main body 10 so as to generate an image of excellent quality even at night or cloudy weather.

The depth camera 35 calculates the depth value of each pixel of an image, and is implemented with any one of stereo, time-of-flight (TOF), and structured light pattern methods, or a hybrid of a combination of thereof. Among them, it is preferable to use the TOF method which has depth recognition in units of mm, fast processing speed, good performance regardless of ambient brightness, and relatively low cost.

According to the TOF method, travel time information is obtained by measuring the delay or phase shift of the modulated infrared light signal for all pixels, and the depth of the subject (plant) is measured by measuring the delay of the optical signal obtained by reflecting the transmitted infrared light signal from the subject as shown in FIG. 6B.

For reference, the larger the distance to the subject, the smaller the size (projection height) of the plant, and herein the red is shown. In addition, the closer the distance to the subject, the larger the size of the plant, and herein blue in contrast to red is shown.

The controller 40 is a monitoring server that is connected to the detector 30 to store and analyze the photographed image as shown in FIG. 1. That is, the controller 40 automatically checks and records the growth state of each plant by analyzing the image photographed by the detector 30, and remotely notifies the manager according to the growth state of the plants.

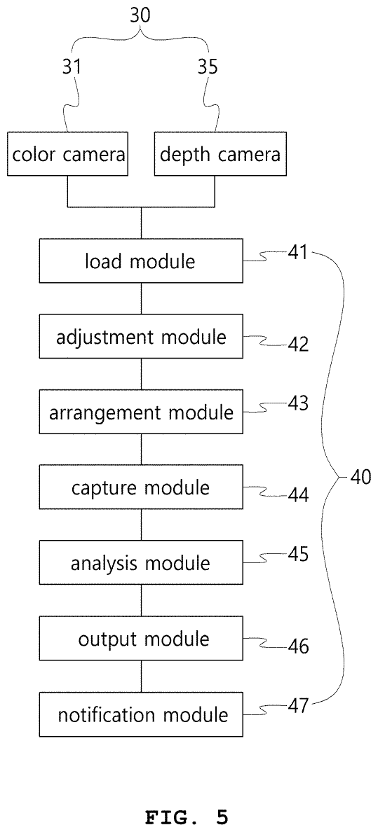

The controller 40 is provided with an image analysis application having a load module 41, an adjustment module 42, an arrangement module 43, a capture module 44, an analysis module 45, an output module 46, and a notification module 47 as shown in FIG. 5.

The load module 41 makes a request for a photographing signal to the color camera 31 and the depth camera 35 to receive the color image and the depth image, respectively, as shown in FIGS. 6A and 6B. Here, the load module 41 receives images continuously by making a request for the photographing signal according to a power source, or by making a request for the photographing signal according to a fixed schedule or administrator command.

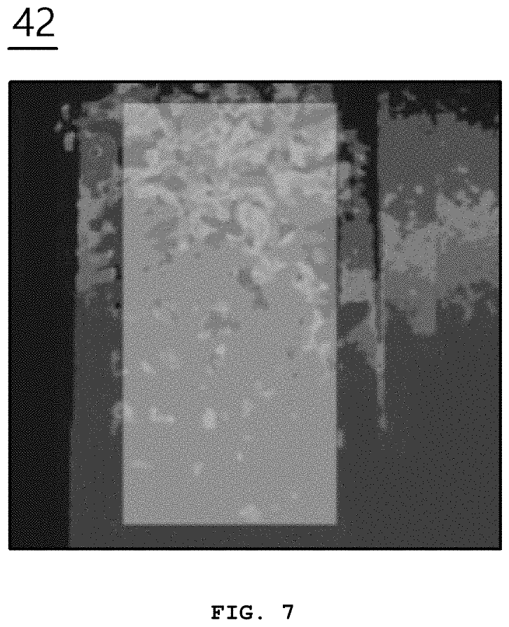

The adjustment module 42 sets the range of the main body 10 as the analysis area in the input color image and depth image. That is, X and Y coordinates are set according to the size of the plantation board 15 displayed on the image or specified in a drag-and-drop manner, as shown in FIG. 7.

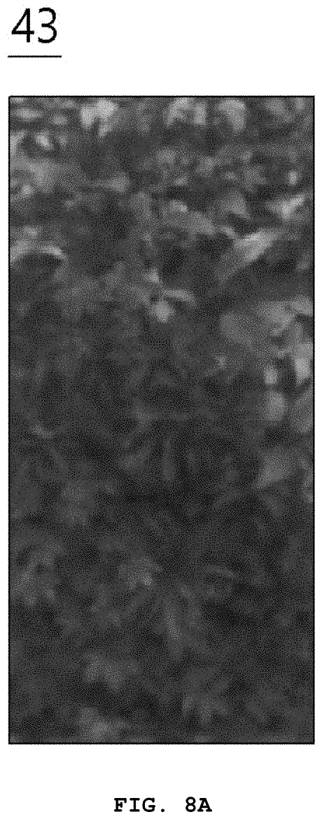

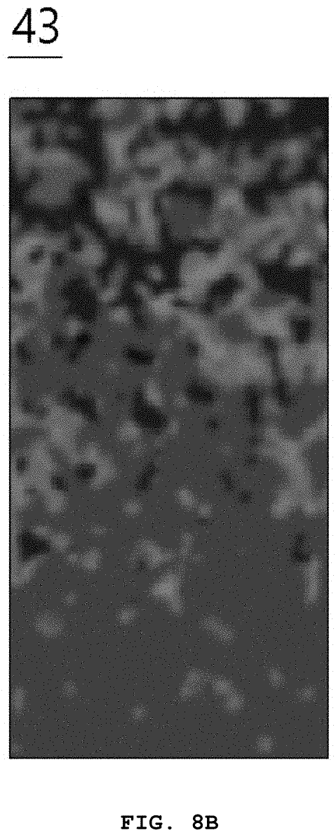

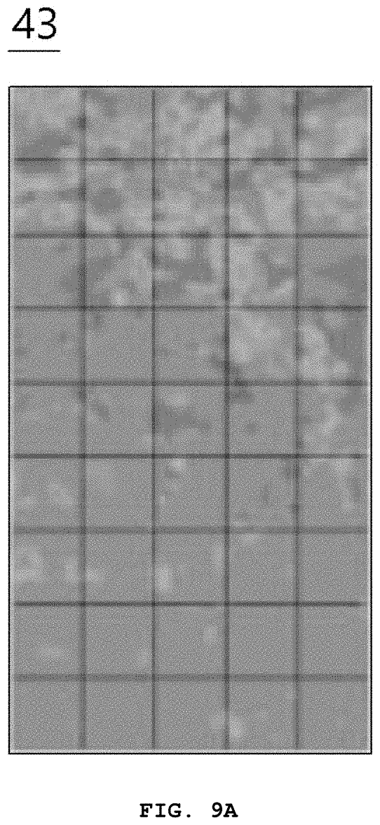

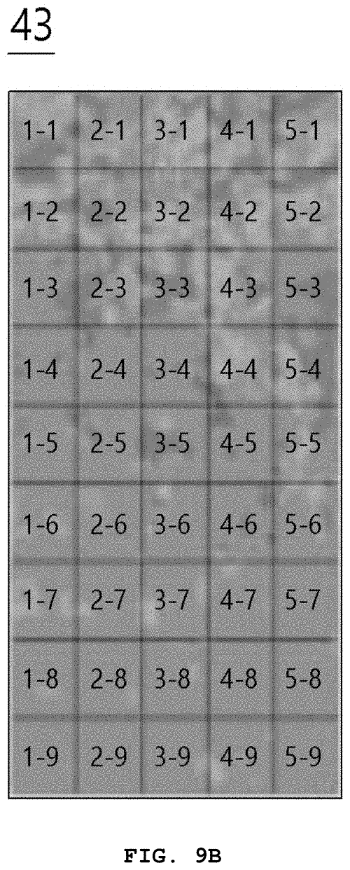

The arrangement module 43 extracts only the set analysis area to partition the boundary area for each planting part. That is, when the analysis area is set, the analysis area is extracted with the unnecessary images being excluded as shown in FIGS. 8A and 8B, and the extracted image is configured so that a boundary area is set for each planting hole 15a as shown in FIG. 9A. Here, the pre-promised boundary areas are preferably assigned numbers of patterns that are easy for the administrator to understand, as shown in FIG. 9B.

The capture module 44 extracts and records images continuously input at a predetermined interval as a picture which is a single image frame, as shown in FIG. 10. That is, the image input at 30 to 60 frames per second is periodically captured every 12 hours or 24 hours and stored as a bitmap file.

The analysis module 45 determines the growth state of the plant using the average color and depth of the plant for each area of the recorded pictures, the output module 46 displays the growth state of each boundary area in the analyzed picture using management target color (red) capable of being distinguishable by a naked eye, and the notification module 47 notifies the manager of the growth state of the plant for each boundary area through the audible and visual information.

Herein, the controller 40 may also perform indoor and outdoor crime prevention, environmental condition monitoring, and resident health care, in addition to analysis of the growth state of the plant. In addition, the controller 40 is equipped with artificial intelligence to check the condition and operation of the watering machine 25.

Hereinafter, a detailed process of implementing the analysis module 45, the output module 46, and the notification module 47 will be described on the basis of examples.

That is, when the first recorded picture is analyzed, as shown in FIG. 10, each area has an average height (depth) of 80 mm or more. The plants in zones 1-8, 2-8, and 2-9 are recorded to be 54 mm, 54 mm, and 48 mm, respectively, and determined to be markedly slower in growth compared with the plants in other zones and thus indicated by the dark red color, which means the plants are included in a management target.

Upon analyzing pictures recorded after 24 hours elapses from the first time, the plant growths in the zones 1-8, 2-8, and 2-9 are rapidly increased to be 64 mm, 56 mm, and 50 mm, respectively, which are determined to be normal. Herein, upon analyzing pictures recorded after 48 hours elapses from the first time, the plant growths in zones 1-8, 2-8, and 2-9 are 65 mm, 57 mm, and 58 mm, respectively, and thus are excluded from the management target, since initial growth is slow but the growth rate gradually increases.

However, considering pictures recorded at the first time and 24 hours after the first time, the plant in the zone 3-9 is found to grow relatively slowly from 65 mm to 67 mm. However, when 48 hours elapses from the first time, the plant in the zone 3-9 is 64 mm and thus is considered to be withered, whereby the plant in zone 3-9 is included in the control object.

The growth status of plant of each zone analyzed by this process is automatically generated as a report of numbers or pictures, and the generated report is output as the monitor and document, and also sent to the administrator's mobile terminal and e-mail address.

Herein, although not shown in a separate drawing, when it is determined that the average color of the plant for each zone is 50% or less compared to the average color of the plant, it is required to perform monitoring so that the manager may check the plants by a naked eye.

Hereinafter, the effectiveness of the wall landscaping system according to the present invention is considered through the experiment.

—Experiment Method—

The growth state of the plant obtained using the camera of the present invention and the growth state of the plant obtained by the actual measurer are compared in order to check the reliability.

—Experiment Conditions—

Glossy-leaf paper plant was planted on the plantation board of the same specifications and conditions, and the height exposed forward from the plantation board was measured every 24 hours from the 7th day after planting. The error in the actual measurement is ±5.0 mm.

—Experiment Result—

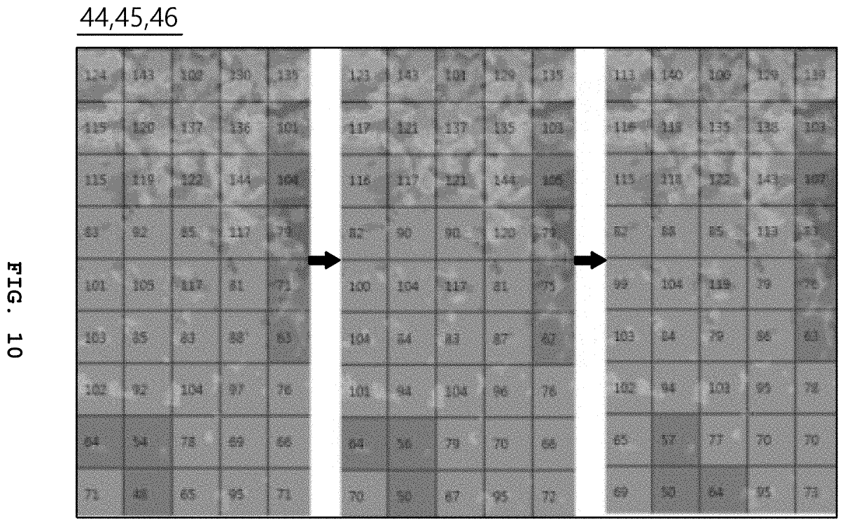

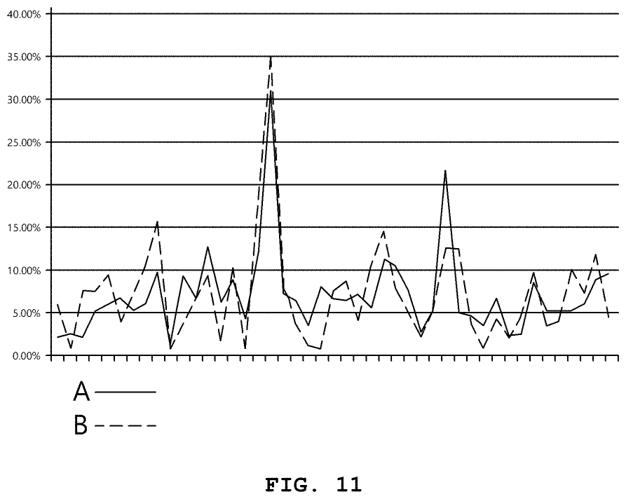

When analyzing the error according to the measured value as a experiment result, the growth state using the camera (A line) and the growth state using the actual measurer (B line) were indicated from 0.65% at a minimum to 35.05% at a maximum, with an average error rate of 7.3%, with reference to FIG. 11.

That is, it may be appreciated that the measured value through the image analysis of the present invention and the actual measured value have an error rate of less than 10%, thereby ensuring the reliability of 90% or more to determine the growth state of the plant. Of course, when big data and artificial intelligence are introduced, it is expected to have the reliability of 95% or more.

Meanwhile, the wall landscaping system according to the present invention may further include an auxiliary part 50 which is configured with any one of an artificial intelligent air purifier 51 and a plant printing billboard 55, or a combination thereof, as shown in FIG. 12.

The air purifier 51 is disposed at the top of the main body 10 to blow air filtered in a wet or dry manner toward the plant to double the self-cleaning and transpiration functions of the plant, thereby creating a more comfortable environment.

The air purifier 51 is equipped with artificial intelligence to monitor the surrounding environment, and to create a comfortable environment automatically or via an alarm according to the environment. That is, the air purifier 51 operates properly according to the ambient temperature, humidity, and illuminance, and also performs self-test periodically to prevent a failure.

In addition, the air purifier 51 may include a cleaning module for cleaning the filter filtering the air, periodically, or automatically according to the polluted state. The cleaning module performs high pressure cleaning using water received from the watering machine 25, or performs cleaning using a brush that rotates or flows in a predetermined direction.

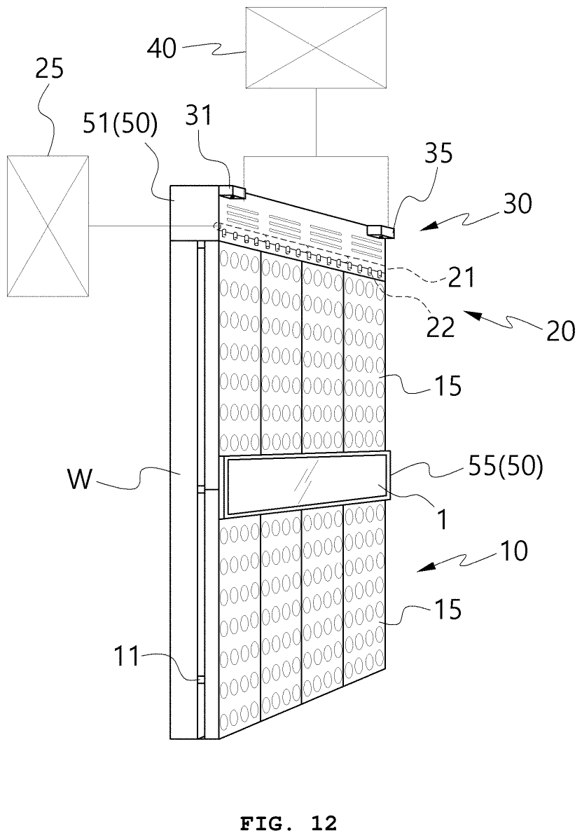

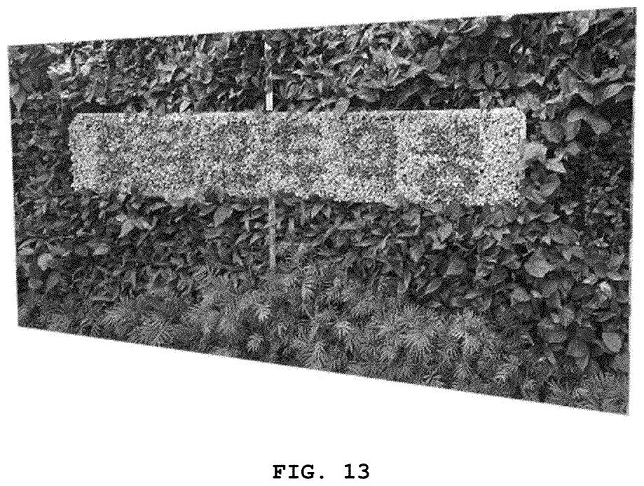

In addition, the billboard 55 is attached to the main body 10 to install the mulching material 1 so that the embedded seeds guide information identified by colors of the plant grown as shown in FIG. 13. In other words, the mulching material 1 is provided so that different seeds are embedded in the form of letters or patterns and pictures.

The seeds are embedded in the mulching material 1 through a seed preparation step S10, an area setting step S20, a seed designation step S30, a seed input step S40, a seed supply step S50, a seed embedment step S60 as shown in FIG. 14.

First, the seed preparation step S10 is a step of selecting and preparing types of seeds embedded in the mulching material 1 and cultivated in the plant cultivation board, in which the user may select the type of the seed randomly or prepare the same among designated plants.

In the region setting step S20, a drawing requested by an advertiser is created in such a manner as to be divided or connected by predetermined areas or lines or dots using drawing creation software such as CAD or illustration. For example, in the case of creating a certain area of drawing, as the seeds are sown and grown, figures such as letters or pictures are distinguished by the areas.

The seed designation step S30 is a step of specifying the seeds to be embedded to each area for the areas set in the area setting step S20, in which the areas are distinguished by colors or symbols for each area, and seeds embedded in the mulching material 1 for each color are specified.

The seed input step S40 is a step of inputting the file created by specifying the seed for each area in the seed designation step S30, to the control unit 100 for controlling the seed embedment device A to be described later. For example, the step is performed so that the pattern file formed is input to the seed embedment device control unit 100 of the computer to read the area set by the controller 100 and control the seed embedment device A, so that the seeds specified according to the area are embedded in the mulching material 1.

In the seed supply step S50, the seed prepared in the seed preparation step S10 is stored in a seed storage hopper 2 provided in the seed embedment device A, so that the seed may be embedded in each area set in the mulching material 1, in which different seeds are included in at least one hopper 2 and thus supplied to the mulching material 1.

In the seed embedding step S60, the seeds are embedded for each area specified in the mulching material 1, in which the seeds specified for each area are supplied and then attached by controlling the seed on-off valve provided in the hopper 2 under the control of the control unit 100 to allow the seeds stored in the hopper to be embedded for each specified area. In addition, the seed embedment position is selected so that the advertiser may attach the seed at a certain interval in consideration of the type of the seed, whereby the operation of the seed embedment device A is controlled automatically. When the seed is embedded, the mulching material 1 is cut to fit the size of the billboard 55 and then attached to the billboard 55.

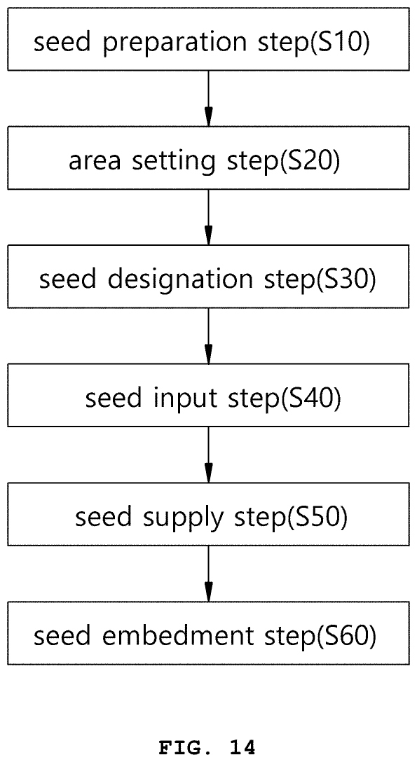

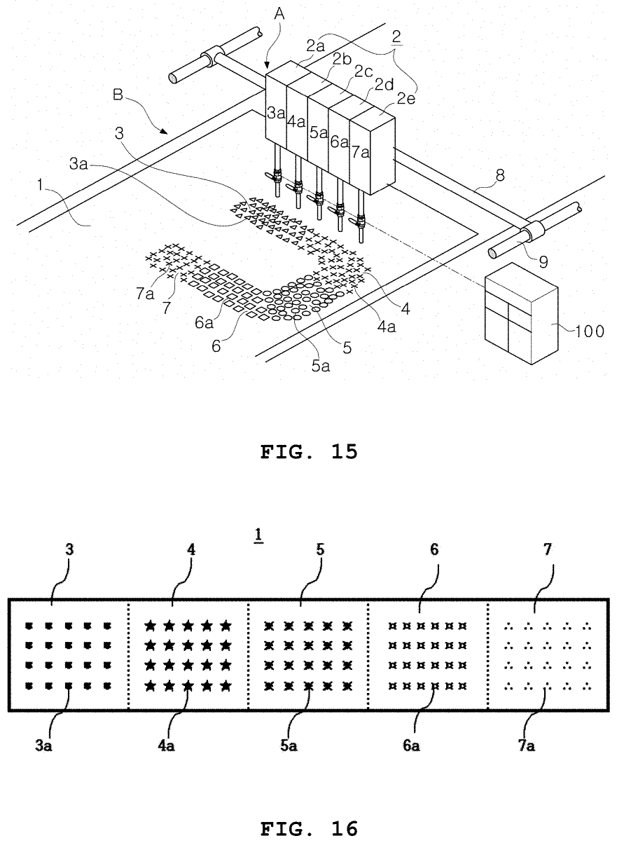

Here, the seed embedment device A is provided so that multiple hoppers 2 equipped with on-off valves are mounted on the horizontal axis 8, a plurality of longitudinal axes 9 is connected to the horizontal axis 8, in the lower part of the hopper 2 is provided a mulching material mounting base B on which the mulching material 1 is placed, and the control unit 100 for controlling the operation of the on-off valve and the movement position of the hopper is included, as shown in FIGS. 15 and 16.

For example, the process of embedding the seed to the mulching material 1 by the seed embedment device A will be described. When the area to which the seed is embedded in the mulching material 1 having a predetermined length is divided into five areas and different seeds are embedded to each area, the control unit 100 opens and closes the on-off valve of the first hopper 2a at regular intervals such that a first seed 3a is embedded in the first area 3.

When the first seed 3a stored in the first hopper 2a is supplied to the first area 3 by opening and closing the on-off valve, the hopper 2 is transferred left to right (or right to left), front to rear (or rear to front) of mulching material 1 through horizontal axis 8 and longitudinal axis 9 at a constant speed within the range of the first area 3, so that the first seed 3a may be embedded in the first area 3 of the mulching material 1 at regular intervals.

Subsequently, the control unit 100 opens and closes the on-off valve of the second hopper 2b at regular intervals such that a second seed 4a is embedded in the second area 4. When the second seed 4a stored in the second hopper 2b is supplied to the second area 4 by opening and closing the on-off valve, the hopper 2 is transferred at a constant speed within the range of the second area 4 from the left to the right, front to rear of the mulching material 1 through the horizontal axis 8 and the longitudinal axis 9, so that the second seed 4a is embedded in the second area 4 of the mulching material 1 at regular intervals.

Subsequently, the controller 100 opens and closes only the on-off valve of the fourth hopper 2d at regular intervals such that a fourth seed 6a is embedded in the fourth area 6. When the fourth seed 6a stored in the fourth hopper 2d is supplied to the fourth area 6 by opening and closing the on-off valve, the hopper 2 is transferred at a constant speed within the range of the fourth area 6 from the left to the right, front to rear of the mulching material 1 through the horizontal axis 8 and the longitudinal axis 9, so that the fourth seed 6a is embedded in the fourth area 6 of the mulching material 1 at regular intervals.

Subsequently, the controller 100 opens and closes only the on-off valve of the fifth hopper 2e at regular intervals such that a fifth seed 7a is embedded in the fifth area 7. When the fifth seed 7a stored in the fifth hopper 2e is supplied to the fifth area 7 by opening and closing the on-off valve, the hopper 2 is transferred at a constant speed within the range of the fifth area 7 from the left to the right, front to rear of the mulching material 1 through the horizontal axis 8 and the longitudinal axis 9, so that the fifth seed 7a is embedded in the fifth area 7 of the mulching material 1 at regular intervals.

In this way, since characters, pictures, and characters can be represented on the wall of the structure as the plant grows, it is possible to obtain promotional effects, as well as aesthetic beauty by combining various colors.

It is apparent to those skilled in the art that the present invention is not limited to the described embodiments, and that various modifications and variations can be made without departing from the spirit and scope of the present invention. Therefore, such modifications or variations will have to belong to the claims of the present invention.

What is claimed is:

1. A wall landscaping system for easy growth management with automatic watering and plant growth analysis, which creates a vertical garden on an interior or exterior wall (W) of a structure, the system comprising:
a main body (10) installed to cover the wall (W) to have a plant grown thereon;
a watering part (20) disposed at an upper end of the main body (10) to supply water to the plant;
a detector (30) disposed around the main body (10) to photograph the plant; and
a controller (40) automatically checking and recording a growth state of the plant by analyzing an image photographed by the detector (30), and remotely notifying a manager according to the growth state of the plant.

2. The system of claim 1, wherein the main body (10) includes: multiple skeletal pipes (11) attached to the wall (W) in a form of a grid; a support plate (12) attached to outer surfaces of the skeletal pipes (11) and finished in a plane; a waterproof cloth (13) attached to an outer surface of the support plate (12) to block moisture; a root-resistant film (14) attached to an outer surface of the waterproof cloth (13) to block penetration of plant roots; and one or more plantation boards (15) attached to an outer surface of the root-resistant film (14) to have the plant grown thereon.

3. The system of claim 2, wherein the plantation board (15) is formed of raw cork or carbonized cork or a mixture thereof, and the plantation board (15) has multiple planting holes (15a) formed on one surface thereof, the planting holes being perforated in a predetermined size and direction and having the plant grown therein, and is integrally formed with a flame-resistant layer (16) that blocks deformation and combustion by heat on an outer surface thereof.

4. The system of claim 1, wherein the flame-resistant layer (16) is composed of 5.0 to 10% by weight of boron, 0.5 to 1.0% by weight of boric acid, 0.5 to 1.5% by weight of phosphoric acid, 10 to 20% by weight of phosphate ester, 1.0 to 2.0% by weight of ethyl phosphoric acid, 0.1 to 1.0 by weight of ammonia, and 1.0 to 5.5% by weight of ethanol amine, remaining balance of unavoidable impurities, and water as a solvent.

5. The system of claim 2, wherein the main body (10) further includes a reinforcing pipe (17) attached between the waterproof cloth (13) and the root-resistant film (14) to increase durability.

6. The system of claim 1, wherein the watering part (20) includes: a watering pipe (21) disposed across the upper end of the main body (10); a watering nozzle (22) continuously arranged at a lower end of the watering pipe (21) to discharge water downward in a drop manner; and a watering machine (25) connected to the watering pipe (21) and supplying water at a prescribed interval.

7. The system of claim 6, wherein the watering machine (25) includes: an on-off valve (25a) supplying water from the outside in accordance with a signal; a water tank (25b) storing the supplied water at a predetermined capacity; a pump (25c) pumping the stored water into the watering pipe (21); a filter (25d) for filtering the pumped water; a pressure reducing valve (25e) controlling a flow rate of the pumped water; and a timer (25f) operating the pump (25d) at a predetermined interval.

8. The system of claim 1, wherein the detection unit (30) includes: a color camera (31) photographing color of the plant that is disposed to be grown toward the front of the main body (10); and a depth camera (35) disposed on the same line as the color camera (31) to photograph a size of the plant to a depth by an infrared light reflected from the main body (10).

9. The system of claim 8, wherein the controller (40) includes: a load module (41) making a request for a color image and a depth image to be received; an adjustment module (42) setting a range of the main body (10) as an analysis area in the color image and the depth image; an arrangement module (43) partitioning a boundary zone for each planting area by extracting only the set analysis area; a capture module (44) extracting and recording an image as a picture at a predetermined interval; an analysis module (45) determining a growth state of the plant by average color and depth of the plant for each zone in the recorded picture; an output module (46) displaying the growth state of each boundary zone in the analyzed picture by colors capable of being distinguished by a naked eye; and a notification module (47) notifying the manager of the growth status of the plant of each boundary zone with visual and audible information.

10. The system of claim 1, wherein the wall landscaping system further includes a auxiliary unit (50) having any one of an artificial air purifier (51) disposed at an upper end of the main body (10) and blowing filtered air toward the plant to double self-cleaning and transpiration of the plant and a billboard (55) having a mulching material (1) to which different seeds are embedded in forms of letters, patterns, and pictures to the main body (10) to guide information identified by colors of the grown plants, or a combination thereof.

11. A method of embedding a seed in the mulching material (1) according to claim 10, which provides easy growth management with automatic watering and plant growth analysis, the method comprising:
preparing different kinds of seeds to be embedded in the mulching material (1) (S10);
setting areas to which the different kind of seeds are embedded in the mulching material (1) (S20);
specifying seeds to be embedded according to the areas set in the mulching material (1) (S30);
inputting a file created by specifying the seeds to be embedded according to the areas set in the mulching material (1) to a control unit (100) that controls an on-off valve operation of a seed embedment device A composed of multiple hoppers (2) each having an on-off valve and the control unit (100) and a position movement of the hopper (S40);
introducing the seeds to be embedded to the set areas into a seed storage hopper (2) (S50); and
embedding the different seeds stored in the hopper (2) to each area (S60).
